(19) United States
(12) Patent Application Publication
(10) Pub. No.: US 2007/0080793 A1
(43) Pub. Date: Apr. 12, 2007

(54) Auto brake alert

(76) Inventor: Gaynell Lynn Blase, Houston, TX (US)

Correspondence Address: GAYNELL BLASE, SUITE 1501, 1701 HERMAN DRIVE, Houston, TX, 77004, US

(21) Appl. No.: 11/247,405

(22) Filed: Oct. 11, 2005

(51) Int. Cl. B60Q 1/00

(52) U.S. Cl. 340/435

(57) ABSTRACT

Embodiments of the invention generally provide a spatial separation apparatus for vehicles. The apparatus of the invention is configured to monitor the distance between the user vehicle and at least one vehicle proximate thereto, and generate a proximity warning for the driver of the vehicle in accordance with the measured spacing, the drivers measured reaction time, the vehicle's physical capabilities, and the ambient conditions.

### BACKGROUND OF THE INVENTION

1. Field of the Invention

Embodiments of the invention generally relate to an apparatus and method for alerting a driver of a vehicle to dangerous conditions so that the driver of the vehicle may take corrective action.

2. Description of the Related Art

The present invention relates to a distance separation system for vehicles. The invention has particular applicability to passenger cars, taxis, trucks, buses, and may be applied to water craft, aircraft, and other types transportation mediums as well. It is to be noted, however, that although the present invention is described below with respect to a vehicle in general, the invention is not intended to be limited to any particular vehicle. Rather, the present invention is contemplated as being applicable to all types and sizes of vehicles.

The most common cause of vehicle collisions is the failure of vehicle operators to maintain an adequate separation distance from other vehicles. Safe separation distance includes both forward/backward separation and left/right separation from nearby vehicles. The safe separation distance required to prevent collisions (both front/back and side to side type collisions) generally depends on the reaction time of the vehicle driver, i.e., how long it takes the driver to process information and to react by either applying the brakes of the vehicle or steering the vehicle away from the impact, the braking distance traversed by the vehicle before it comes to a stop or starts to decelerate faster than the vehicle it is likely to contact, and/or the difference in the deceleration rates between the two colliding vehicles, i.e., if the forward-most vehicle is decelerating faster than the rearward vehicle, then a collision is more likely as a result of the inherent decreasing separation distance. Each of the above noted factors may vary according to the surrounding conditions at the time of driving.

U.S. Pat. No. 3,681,750 to Larka (1972) discloses a passive device which detects ultrasonic signals; however, this device merely detects the presence of moving objects and does not inform the operator of the distance to these objects nor of their velocity, relative to the vehicle. Several types of ultrasonic collision avoidance systems have been proposed in, for example, U.S. Pat. No. 3,802,397 to Sindle (1974), U.S. Pat. No. 4,240,152 to Duncan and Wiley (1980), U.S. Pat. No. 4,260,980 to Bates (1981), U.S. Pat. No. 4,442,512 to Sigeeyuki and Akite (1980), U.S. Pat. No. 4,450,430 to Barishpolsky (1980), U.S. Pat. No. 4,626,850 to Chey (1986), and U.S. Pat. No. 4,694,295 to Miller and Pitton (1987). All of these systems have certain factors in common. For example, all of these inventions generally require numerous transducers along with associated circuitry to scan pertinent areas surrounding the vehicle. This greatly increases the cost of the system. Also, use of multiple transducers increases the complexity of the system, thereby decreasing dependability. All of these inventions also generally utilize transducers mounted in a way that the emitted ultrasonic signal is perpendicular to the vehicle. This arrangement does not make effective use of the natural shape of the signal since, at very close distances, the width of the signal is very narrow as opposed to having a much larger width at greater distances. As a consequence of this arrangement, multiple transducers are needed in order to scan the entire side of the vehicle. Further, all of the above noted invention generally require separate mountings for each transducer to scan an individual area. Transducers which are located at different points on the vehicle require excessive lengths of cable to interconnect and coordinate their activities, creating logistical and design problems. All of the noted inventions are also generally unable to differentiate between a stationary object and one that is moving. Stationary objects create false warnings which hinder rather than assist the operator. Their operation merely warns of objects when they are detected within a certain fixed distance. They do not compensate for varying vehicle speeds, which necessarily dictate a greater warning distance. All of the inventions are also unable to compensate for the addition of a trailer which would effectively void any protection provided by the system since any object located adjacent the trailer would go undetected. Also, the trailer itself would cause a false warning since the transducer used to scan the rear area, if provided, would detect the reflected ultrasonic signal from the trailer. All of the above noted inventions also utilize dedicated electrical circuits which do not allow for an operator to program in preferred warning distances.

Although there are many anti-collision systems available in the art, none of the conventional systems have the novel features of the present invention. For example, the present invention provides spatial monitoring for front, back, and both sides of the vehicle. The present invention provides the user the ability to program the minimum safe distance, along with parameters that contribute to the minimum safe distance, such as ambient conditions, vehicle parameters, etc. The present invention also provides multiple levels of warnings, e.g., a normal warning when spatial separation has been compromised and an urgent warning when spatial separation has been compromised and impact is likely without immediate action. The present invention also provides an embodiment where the installation of the apparatus does not require substantial wiring, as the sensors for the apparatus my use either radio technology to communicate, or alternatively, the sensors may piggyback off of an existing power supply for the vehicle and transmit signals from the sensor to the controller via existing wiring in the vehicle.

Embodiments of the invention address the challenges presented above.

### SUMMARY OF THE INVENTION

Embodiments of the invention generally provide a vehicle spatial separation apparatus. The apparatus of the invention generally includes at least one sensor configured to measure distances between a vehicle having the spatial separation apparatus and vehicles in the vacinity of the vehicle having the spatial separation apparatus. The spatial separation apparatus is configured to generate a normal warning when a predetermined spatial separation has been violated, and to generate an urgent warning when spatial separation has been violated in a manner that may cause an impact without immediate action.

Embodiments of the invention may further provide a. A vehicle spatial separation apparatus, comprising a first distance sensor positioned on an outer forward facing surface of a vehicle, a microprocessor controller in electrical communication with the first distance sensor, and an driver warning module positioned in an interior of the vehicle and being in electrical communication with the microprocessor controller. The first distance sensor is positioned in a headlight fixture on the vehicle and is in electrical communication with the microprocessor controller via power supply wiring for a headlight positioned in the fixture.

### BRIEF DESCRIPTION OF THE DRAWINGS

So that the manner in which the above recited features of the present invention are attained can be understood in detail, a more particular description of the invention, briefly summarized above, may be had by reference to the embodiments thereof, which are illustrated in the appended drawings. It is to be noted, however, that the appended drawings illustrate only typical embodiments of this invention, and are therefore, not to be considered limiting of its scope, for the invention may admit to other equally effective embodiments.

FIG. 1 illustrates a general layout of an embodiment of the invention.

FIG. 2a illustrates a simplified front view of an exemplary vehicle of the invention.

FIG. 2b illustrates a sectional view of an exemplary signal emitter/receiver of the invention.

FIG. 3 illustrates a front view of an exemplary display/input panel of the invention.

FIG. 4 illustrates a simplified schematic of the electronics of the invention.

### DETAILED DESCRIPTION OF THE PREFERRED EMBODIMENT

The present invention generally provides a distance separation alert system that is configured to notify the driver of a vehicle when a predetermined spatial separation between the drivers vehicle and other vehicles is violated. The spatial separation alert system of the invention is configured to monitor and alert for separation violations around the complete perimeter of the vehicle, i.e., front, back, and sides of the driver's vehicle.

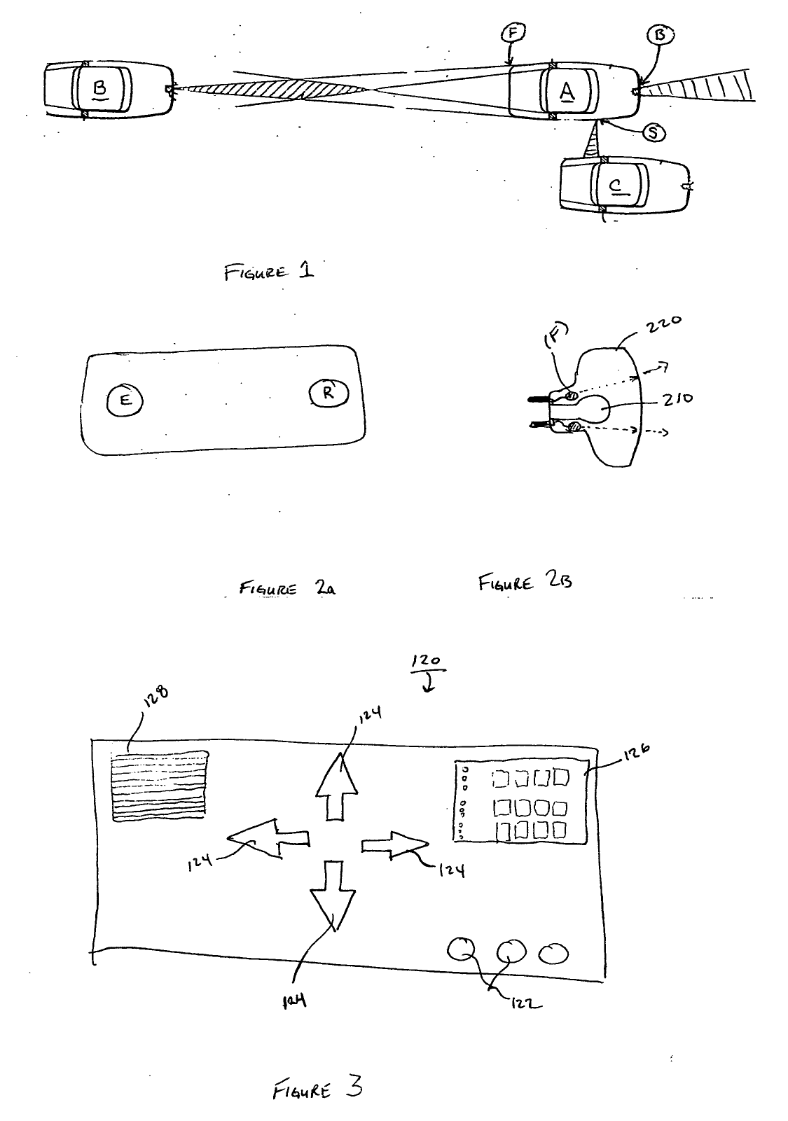

FIG. 1 illustrates general layout of an operational embodiment of the spatial separation apparatus 100 (element 100 is shown in schematic in FIG. 4) of the invention. The spatial separation apparatus 100 of the invention is illustrated as being positioned in vehicle A, and is operating to monitor and warn the driver of vehicle A as to the spatial separation of vehicle B and vehicle C relative to vehicle A. The spatial separation apparatus 100 generally includes a plurality of signal emitters/receivers F, S, B that are in communication with a system controller 110, that is also in communication with an operator display/input device 120, as illustrated in FIG. 4. The emitters/receivers may be ultrasonic, radio, sonar, infrared, radar, or other type of sensor that is capable of making distance measurements at distances of up to 150 feet.

The signal emitters/receivers F, S, B generally comprise devices capable of emitting a signal that may be used to measure the distance between the respective signal emitter and another object positioned proximate the signal emitter. Generally, the process of determining the distance from the respective emitter to the proximate object includes sending at least one signal from the emitter and determining the amount of time it takes for the signal to travel to the proximate object, bounce off of the object, and return to the emitter for collection by a signal receiver.

Since the propagation speed of the signal from the emitter is generally a known parameter, Newtonian physical principles may be used to determine the distance the object is from the emitter, i.e., the distance a first object is from another object in this situation may be calculated as the propagation speed of the signal multiplied by the time the signal takes to traverse the distance between the emitter and the object.

The emitters/receivers F, S, B generally represent a front side vehicle emitter/receiver (F), a backside or rearward facing vehicle emitter/receiver (B), and at least one vehicle side emitter/receiver (S). The emitters/receivers F, S, B may generally operate on optical signal technology, e.g., the emitters/receivers F, S, B may emit an optical signal, such as a laser light signal, that has a known wavelength and/or propagation speed that may be reflected off of the other vehicles B and C and subsequently received by the respective emitter/receiver. The emitters/receivers F, S, B may also generally operate on radio signal technology, e.g., the emitters/receivers F, S, B may emit a radio frequency signal that has a known wavelength and/or propagation speed that may be reflected off of the other vehicles B and C and subsequently received by the respective emitter/receiver. The emitters/receivers F, S, B may also generally operate on acoustic signal technology, e.g., the emitters/receivers F, S, B may emit an acoustic signal that has a known wavelength and/or propagation speed that may be reflected off of the other vehicles B and C and subsequently received by the respective emitter/receiver. The emitters/receivers F, S, B may also generally operate on ultrasonic signal technology, e.g., the emitters/receivers F, S, B may emit an ultrasonic signal that has a known wavelength and/or propagation speed that may be reflected off of the other vehicles B and C and subsequently received by the respective emitter/receiver.

Regardless of the particular emitter/receiver configuration used, the spatial separation apparatus 100 generally utilizes a controller 110 to control the operation of the emitters/receivers F, S, B. The controller 110 may be a microprocessor-type controller configured to receive inputs from a user or other sensors in communication with the controller 110, process the inputs in accordance with at least one predetermined control algorithm, and generate control signals in accordance with the control algorithm. Other exemplary controller configurations include programmable devices such as various, general hard wired control circuits, and existing controllers that are already present in the vehicle that may be leached by the control separation apparatus 100 of the invention.

With regard to the inputs that the controller 110 receives from the user, the spatial separation apparatus 100 of the invention also includes an input/output device 120. The input/output device 120, which is also illustrated in FIG. 3, generally includes mechanisms that allow the device 120 to receive inputs from the user and mechanisms to convey or display information generated by the controller 110 back to the user. Exemplary input devices for the input/output device 120 include buttons 122, and exemplary output/display devices include optical indicators 124, display panel 126, and audible indicator 128.

Returning to FIG. 1, the spatial separation apparatus 100 is mounted on vehicle A and is used to monitor spatial separation between vehicle A and vehicles B and C. Separation between vehicle A and vehicle B is generally referred to as frontal separation. The frontal separation between vehicle A and vehicle B is managed by at least one forward looking sensor (F as illustrated in FIG. 4) that is configured to measure the distance between the front of vehicle A and the back of vehicle B. The forward looking sensor (F) is generally mounted on the front of vehicle A, and may be mounted in the headlight assembly of vehicle A for example. The side mounted sensors (S) may be mounted on the side of vehicle A. In one embodiment of the invention, the side mounted sensors (S) may be mounted in the side marker lights for vehicle A. In this configuration, the side mounted sensors (S) may be configured to leach off of the power supply for the marker lights and use the power supply wiring to transmit sensor signals to the controller 110 in a back feed-type of operation, as if further discussed herein. The rearward facing sensor (B) is similarly configured to the forward facing sensor (F), as the rearward facing sensor (B) may be positioned in one of the rearward facing lights of the vehicle, i.e., in one or more of the rearward facing tail lights, reverse lights, signal indicator lights, etc. Alternatively, any of the sensors (F, S, B) may be a stand alone sensor that is added on to or attached to the vehicle and either contains its own power supply or is wired into a power supply from the vehicle.

The spatial separation apparatus 100 may be programmed with a plurality of separation parameters, including a minimum separation parameter. For example, the spatial separation apparatus 100 may be programmed such that when vehicle A is traveling 50 mph, that the minimum frontal separation is 100 ft. In this configuration, when sensor F measures that the frontal separation is 100 ft or less, then the spatial separation apparatus 100 may warn the user that the minimum frontal separation has been violated. The user may then slow down to increase the frontal separation to a safe distance and the spatial separation apparatus 100 will continue to monitor the frontal separation distance.

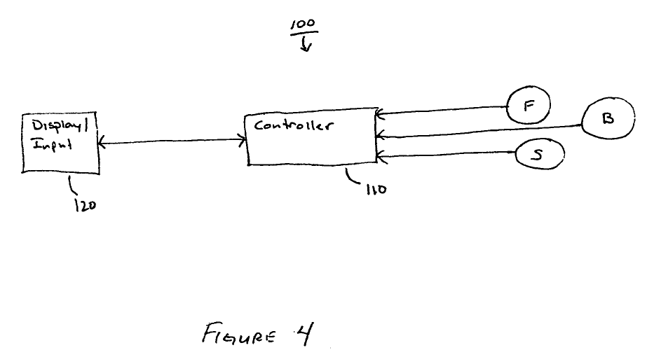

FIGS. 2a and 2b illustrate an exemplary configuration of the forward looking sensor (F). FIG. 2a illustrates an exemplary front view of vehicle A. Elements E and R represent the headlights of vehicle A. In one exemplary embodiment of the invention, the forward looking sensor (F) may be positioned in the headlight of vehicle A, as illustrated in FIG. 2a. In some embodiments of the invention the sensor (F) may include a separate emitter (E) and receiver (R), and in this embodiment, the emitter (E) and receiver (R) may be positioned in the same or in separate light assemblies. For example, as illustrated in FIG. 2b, which is a cross sectional view of an exemplary headlight for vehicle A, the forward looking sensor (F) may be positioned in the headlight housing 220 radially outward of the headlight bulb 210. In this configuration, the sensor (F) may connect to the power supply for the bulb 210. Further, the sensor (F) may be configured to transmit control signals through the power supply wires for the bulb 210. In this configuration, the controller 110 illustrated in FIG. 4 does not have to be physically hard wired to the sensor (F). Rather, the sensor (F) is powered by the headlight circuitry power and the sensor (F) transmits a signal to the controller 110 through the power supply wires for the bulb 210, as the controller 110 is also in communication with the power supply for the vehicle. This back feed-type of signal transmission simply requires that the controller 110 monitor the power supply wiring for back feed signals being transmitted by the sensor (F), and the signals being transmitted by the respective sensors may be transmitted over the power supply lines at particular frequencies that may be easily detected by the receiver (controller) at the other end of the power supply wire without interruption or interference to the power supply operation. The result of this configuration is that there is no need to hard wire the spatial separation apparatus 100 of the invention, and the existing wires of the vehicle are used to transmit signals. Alternatively, the sensor (F) may include a transmitter and/or receiver that is configured to communicate with the controller 110 without using wires. The spatial separation apparatus 100 also generally includes at least one side sensor (S) facing to measure the distance between vehicle A and a vehicle positioned along side vehicle A, i.e., vehicle C, and at least one rearwardly facing sensor (B) configured to measure the distance from the rear of vehicle A to a vehicle traveling behind vehicle A (not shown). These sensors may operate in generally the same manner as the forward looking sensor (F) described above.

FIG. 3 illustrates a front view of an exemplary display/input panel 120 of the invention. The display/input panel 120 is in electrical communication with the controller 110 of the separation apparatus 100 and operates in accordance with the output signals of the controller 110 that are provided to the display/input panel 120. In one embodiment of the invention, the controller 110 may be incorporated into the display/input panel 120 to minimize components, manufacturing costs, and the complexity of the system. The display/input panel 120 generally includes four directional spatial warning indicators 124. The warning indicators 124 represent the direction of the warning, e.g., when the warning indicator representing the forward looking sensor (F) is illuminated, then the driver of the vehicle knows that the proximity spatial warning associated with this indicator 124 is in front of the vehicle. As such, the warning indicators 124 may be configured as arrows (as shown in FIG. 3) to easily represent the direction of the proximity warning to the driver. The warning indicators 124 may generally comprise light emitting diodes (LEDs), and in at least one embodiment of the invention, the indicators 124 may be multi-wavelength LEDs configured to emit light of different colors. In this embodiment, for example, when there are no proximity threats, the indicators may emit a green light. However, when there is a minimal or possible proximity threat, the appropriate indictor may emit a yellow or red light. The user may then easily view the display/input panel 120 and quickly determine in what direction the threat is and take corrective action.

The display/input panel 120 further includes an audible warning device 128, which generally includes a buzzer, speaker, or other sound emitting device. The audible warning device is generally configured to emit an audible warning when the predetermined spatial proximity zone around the vehicle has been violated. In order to speed reaction time, the audible warning device may be configured to emit different audible warnings for different proximity violations. For example, if a frontal proximity violation occurs, the audible warning device 128 may be configured to emit a sound that the driver of the vehicle associates with a frontal violation. The audible warning may also include a voice representation that actually says “frontal warning” is desired. Distinct audible warnings may be generated to represent various spatial violations. The intent of the distinct audible warnings is to allow the driver to recognize the threat with minimal information processing, i.e., minimal thinking time, which facilitates optimal reaction time to the threat.

The display/input panel 120 further includes a display 126. The display panel 126 is generally used to display programming and setup information to the user. For example, the display/input panel may include a plurality of input buttons 122 that may be used to set up the operational parameters of the device. In this embodiment, the display 126 may be used to query the user for inputs and display inputs for selection by the user. Exemplary inputs for the separation apparatus 100 of the invention include the type of vehicle, road or weather conditions, and other parameters that may assist in determining the appropriate spatial separation between vehicles. These parameters may be used by the controller 110 to determine appropriate spatial warning zones and parameters for the user's vehicle in the given conditions. The display 126 and buttons 122 may also be used to manually input actual separation parameters if the user does not want the controller 110 to calculate the separation parameters from user inputs.

In one embodiment of the invention, the display/input panel 120 may comprise a radar detector. In this embodiment, the display and control features of the separation control apparatus of the invention may be contained in the same housing as the radar detector. This configuration allows for easy installation. In yet another embodiment of the invention, one or more of the sensors (F, B, and S) may also be contained in the radar detector housing. In this embodiment the spatial separation apparatus is completely self contained and would not require any additional wiring or modifications to the vehicle for installation.

In another embodiment of the invention, the spatial separation apparatus 100 of the invention may include several proximity warning indicators, aside from the audible and visual indicators discussed above. For example, the spatial separation apparatus 100 may include an apparatus configured to vibrate the steering wheel of the vehicle when a proximity alarm occurs. Similarly, the spatial separation apparatus 100 may be configured to vibrate the drivers seat when a proximity alarm occurs. The general intent of the spatial separation apparatus 100 is to warn the drive of a potential accident resulting from poor separation between vehicles, which often happens when a driver falls asleep or becomes somewhat dazed or preoccupied by something else. The vibrating warning feature of the present invention has been shown to be successful in combating drowsiness and preoccupation.

In operation, the spatial separation apparatus 100 of the invention is configured to alert the driver of a vehicle when another vehicle is in a predetermined proximity zone (caution zone) for their vehicle. In order to generate accurate warnings, the spatial separation apparatus 100 of the invention must accomplish several tasks. First, the spatial separation apparatus 100 must determine what the safe proximity zone for the vehicle is for the current conditions. More particularly, when the vehicle is moving at 25 mph, then the proximity zone may be 45 feet in front of the vehicle, as it may be known that the vehicle could come to a complete stop in less than 45 feet if a warning were generated. The determination of the safe proximity zone may be inputted by the user, or more preferably, calculated by the system controller 110. When the system controller calculates the proximity zone, parameters such as the vehicle speed, weight, road conditions, braking power available, and average driver reaction time may be considered in the calculations. The parameters considered by the controller 110 may be either inputted by the user, or determined by the controller through, for example, a link with the vehicles speedometer, a ground or pavement sensor, etc. Additionally, the controller may be configured to monitor the drivers reaction time to warnings, and adjust subsequent warnings in accordance with the observed reaction times to allow for better driver opportunity to avoid collisions. In one embodiment of the invention, the controller 110 may initialize by testing the drivers reaction times through, for example, emitting a warning and timing how long it takes the driver to depress the brake. This reaction time may then be used by the controller to determine a safe proximity zone for the driver.

Once the spatial separation apparatus 100 has initialized, i.e., once the controller 110 has determined the appropriate proximity zone, then the spatial separation apparatus 100 goes into a monitoring mode. In the monitoring mode the spatial separation apparatus 100 is continually receiving distance measurements form a plurality of distance sensors (F, S, B, etc.). The distances to proximate objects or vehicles determined by the sensors is compared with the determined proximity zone by the controller 110, and if the distance is within the proximity zone, then the controller sets off a warning signal on the display panel 120.

The process of warning the driver to a proximity violation is a primary feature of the invention. The warning process of the invention includes multiple warnings that occur in multiple stages and in multiple mediums. For example, if a frontal proximity warning is generated by the controller 110 indicating that a vehicle is close to or slightly within the proximity zone, then the display panel 120 may illuminate a yellow light 124 representing a caution warning for the front of the vehicle. If the distance between the two vehicles continues to decrease, then the controller 110 may escalate the warning to an urgent warning that may be represented by a red indicator light 124 accompanied by an audible warning. The escalation of the warning from cautionary to urgent may be made by the controller 110 in accordance with several calculations. One such calculation may be a determination that the frontally located vehicle is decelerating at a higher rate than the drivers vehicle, and as such, an impact is imminent if greater breaking is not applied by the driver. In sum, the controller 110 may be configured not only to measure distance to targets, but also to determine the rate of closure of the targets and generate appropriate warnings to the driver in accordance with driver's own reaction times, the physical characteristics of the vehicle, and the ambient conditions.

While the foregoing is directed to embodiments of the present invention, other and further embodiments of the invention may be devised without departing from the basic scope thereof, and the scope thereof is determined by the claims that follow.

1. A vehicle spatial separation apparatus, comprising:
a first distance sensor positioned on an outer forward facing surface of a vehicle;
a microprocessor controller in electrical communication with the first distance sensor; and
an driver warning module positioned in an interior of the vehicle and being in electrical communication with the microprocessor controller,
wherein the first distance sensor is positioned in a headlight fixture on the vehicle and is in electrical communication with the microprocessor controller via power supply wiring for a headlight positioned in the fixture.

2. The vehicle spatial separation apparatus of claim 1, wherein the driver warning module comprises at least one of an audible and a visible warning device.

3. The vehicle spatial separation apparatus of claim 2, wherein the microprocessor controller is configured to determine a distance between the vehicle having the separation device and another vehicle, and to activate the driver warning module when the distance between the vehicle having the separation device and the another vehicle decreases below a predetermined distance.

4. The vehicle spatial separation apparatus of claim 3, further comprising a second distance sensor positioned on a sideways facing surface of the vehicle in a side indicator light of the vehicle, the second sensor being in communication with the microprocessor controller through a power supply wire connected to the side indicator light.

5. The vehicle spatial separation apparatus of claim 4, further comprising a third distance sensor positioned on a rearward facing surface of the vehicle in a brake indicator light of the vehicle, the third sensor being in communication with the microprocessor controller through a power supply wire connected to the brake indicator light

6. The vehicle spatial separation apparatus of claim 1, wherein the first distance sensor comprises at least one of a radar sensor, a sonar sensor, a radio frequency sensor, and an infrared sensor.

7. The vehicle spatial separation apparatus of claim 1, wherein the microprocessor controller is positioned inside a radar detector and communicates with the first distance sensor through a radar detector power cable that is connected to a power system of the vehicle.

8. The vehicle spatial separation apparatus of claim 3, wherein the microprocessor controller is further configured to activate the driver warning module in increasing intensities in accordance with a decreasing distance between the vehicle having the separation device and the another vehicle.

9. A vehicle separation warning device, comprising:
a microprocessor controller positioned in a vehicle and being in electrical communication with a power supply of the vehicle;
at least one distance sensor positioned on the vehicle and being configured to measure a distance between the vehicle and other objects, the at least one sensor being in electrical communication with the power supply of the vehicle and communicating with the microprocessor controller through the power supply; and
a driver warning module positioned in an interior of the vehicle proximate a driver of the vehicle, the driver warning module being configured to emit at least one of an audible and a visible warning to the driver when the microprocessor controller determines that the distance between the vehicle and another object is closer than a predetermined distance.

10. The vehicle separation warning device of claim 9, wherein the at least one distance sensor comprises a forward facing sensor positioned in a headlight of the vehicle and in electrical communication with a power supply for the headlight.

11. The vehicle separation warning device of claim 10, wherein the forward facing sensor comprises at least one of a radar sensor, a sonar sensor, a radio frequency sensor, and an infrared sensor.

12. The vehicle separation warning device of claim 12, further comprising a side facing sensor positioned in an indicator light positioned on a side facing surface of the vehicle, the side facing sensor being in electrical communication with a power supply for the indicator light.

13. The vehicle separation warning device of claim 13, further comprising a rearward facing sensor positioned in a brake light positioned on a rearward facing surface of the vehicle, the rearward facing sensor being in electrical communication with a power supply for the brake light.

14. The vehicle separation warning device of claim 14, wherein the microprocessor controller is positioned inside a radar detector and communicates with the at least one distance sensor through a radar detector power cable that is connected to a power system of the vehicle.

15. The vehicle separation warning device of claim 15, wherein the microprocessor controller is configured to activate the driver warning module in increasing intensities in accordance with a decreasing distance between the vehicle having the separation device and the another vehicle

16. A vehicle separation warning device, comprising:
a controller in electrical communication with a power supply of a vehicle;
a distance sensor positioned on the vehicle and being configured to measure a distance between the vehicle and other vehicles, the distance sensor being in electrical communication with the controller through power supply wires; and
a audible and visible driver warning device in communication with the controller,
wherein the controller is configured to execute the following steps:
receiving a distance measurement from the distance sensor via the power supply wires;
determining a separation distance between the vehicle and proximate vehicle;
determining if the separation distance is within a caution zone; and
activating the warning device if the separation distance is determined to be within the caution zone.

17. The vehicle separation warning device of claim 17, wherein the distance sensor comprises at least one of a radar sensor, a sonar sensor, a radio frequency sensor, and an infrared sensor mounted in a headlight fixture of the vehicle and being in electrical communication with a power supply wire for the headlight.

18. The vehicle separation warning device of claim 18, further comprising a second distance sensor positioned in at least one of a side vehicle indicator light fixture and a brake light fixture and being in communication with the controller via power supply wires for the lights.
